(19) United States
(12) Patent Application Publication
(10) Pub. No.: US 2006/0006697 A1
(43) Pub. Date: Jan. 12, 2006

(54) Method for manufacturing an add-on unit

(75) Inventors: Sascha Debuan, Stuttgart (DE); Manfred Hanisch, Ostelsheim (DE); Kai Heller, Stuttgart (DE); Dirk Lindenau, Stuttgart (DE); Detlef Linz, Weyhe (DE); Anton Mayer, Rottenburg (DE); Frank Schaeffer, Blender (DE); Holger Schubert, Neckarsulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/178,660

(22) Filed: Jul. 11, 2005

(30) Foreign Application Priority Data
Jul. 9, 2004 (DE) DE 102004033184.7

(51) Int. Cl. B60J 5/00

(52) U.S. Cl. 296/193.01

(57) ABSTRACT

A method for manufacturing an add-on unit made up of car body sheets, the add-on unit having at least two overlapping sheets, in which one edge area of a first sheet is folded over an edge area of a second sheet. In order to enable direct assembly of the add-on unit into the body-in-white, after the folding process, the edge areas of the sheets are joined together in sections by applying heat on one side. In addition an add-on unit is manufactured using this method.

Priority is claimed to German Patent Application No. DE 10 2004 033 184.7, filed on Jul. 9, 2004, the entire disclosure of which is incorporated by reference herein.

The present invention relates to a method for manufacturing an add-on unit made up of car body sheets, the add-on unit having at least two overlapping sheets, as well as to an add-on unit which is assembled into a motor vehicle body.

### BACKGROUND

In automobile production, the necessity frequently arises during body assembly to initially assemble add-on units, which include two or multiple individual sheets, by joining the sheets and to mount them subsequently on the body. A motor vehicle door is such an add-on unit, for example. It must be ensured that the add-on unit is dimensionally stable and is unable to become distorted during transport or during assembly into the body or during subsequent manufacturing steps.

A generic add-on unit is known from DE 101 16 282 A1 which includes an inner sheet and an outer sheet which are joined together at the edges by a fold connection and an adhesive. However, the problem arises in such joints that the dimensional stability of the positive fit is still insufficient to secure the units together and the units may therefore shift against each other. In addition, heating of the units during paint work results in expansion of the unjoined workpieces which also results in a shift of the units. Therefore, the adhesive must be hardened prior to assembly via an additional heat treatment which, however, adds up to a loss in time, poor integration of the add-on units manufacturing process into the production line, and thereby to an overall rise in cost of the body assembly.

### SUMMARY OF THE INVENTION

An object of the present invention is to provide a method for manufacturing an add-on unit which makes it possible to assemble the add-on unit into the body-in-white directly after the folding process without a loss in dimensional stability. Furthermore, an add-on unit manufacturable by this method is proposed.

The present invention provides a method manufacturing an add-on unit made up of car body sheets, the add-on unit having at least two overlapping sheets, in which an edge area of a first sheet is folded over an edge area of a second sheet, wherein after completion of the folding process the edge areas (7, 9) of the sheets (3, 5) are joined together in sections by applying heat on one side. The present invention also provides an add-on unit which is assembled into a motor vehicle body, the add-on unit including at least two sheets, one edge area of a first sheet being folded around the edge area of a second sheet, wherein the folded part (21) of the first sheet (3) is joined in sections in its edge area (7) with the second sheet (5) by welded joints (11). According to the method of the present invention, the two sheets are inhibited from shifting before or during assembly and the entire add-on unit has great dimensional stability.

Heat is advantageously applied on one side with the aid of a laser beam. This represents a simple and very precise method for joining the edge areas using low heat input.

The edge areas of the sheets are advantageously joined by fillet welding, thereby achieving an even greater stability of the add-on unit. Furthermore, the area of the fold of the two sheets is sealed and additional sealing measures on the finished add-on unit may be omitted, which lowers the production costs substantially.

In a further advantageous embodiment, an adhesive layer is applied to the edge area of one and/or both sheets prior to the folding process. Greater stability of the joint may thus be achieved after hardening of the adhesive without the disadvantage that the adhesive must first harden prior to assembly.

In an advantageous embodiment, the welded joints, produced by applying heat on one side, are provided in the edge areas of the add-on unit where the add-on unit has the greatest rigidity. This makes it possible that in subsequent manufacturing steps, which are associated with heat application on the add-on unit, no lasting deformations of the add-on unit due to thermal expansion remain.

The edge areas of the sheets are advantageously joined via a fillet joint. The edge areas of the sheets may alternatively be joined via a lap joint. The generally used joint geometries are thus covered by the method according to the present invention, resulting in a broad range of applications.

Furthermore, an add-on unit is proposed in which the folded part of the first sheet is joined in sections in its edge area with the second sheet by welding.

Further embodiments and advantages of the present invention arise from the description.

### BRIEF DESCRIPTION OF THE DRAWINGS

The present invention is explained in greater detail based on two exemplary embodiments and the drawings, in which:

FIG. 1 shows an embodiment of the edge area of an add-on unit;

FIG. 2 shows an alternative embodiment of the edge area of an add-on unit;

FIG. 3 shows an exemplary embodiment of an add-on unit prior to assembly in the motor vehicle body; and

FIG. 4 shows another exemplary embodiment of an add-on unit prior to assembly in the motor vehicle body.

### DETAILED DESCRIPTION

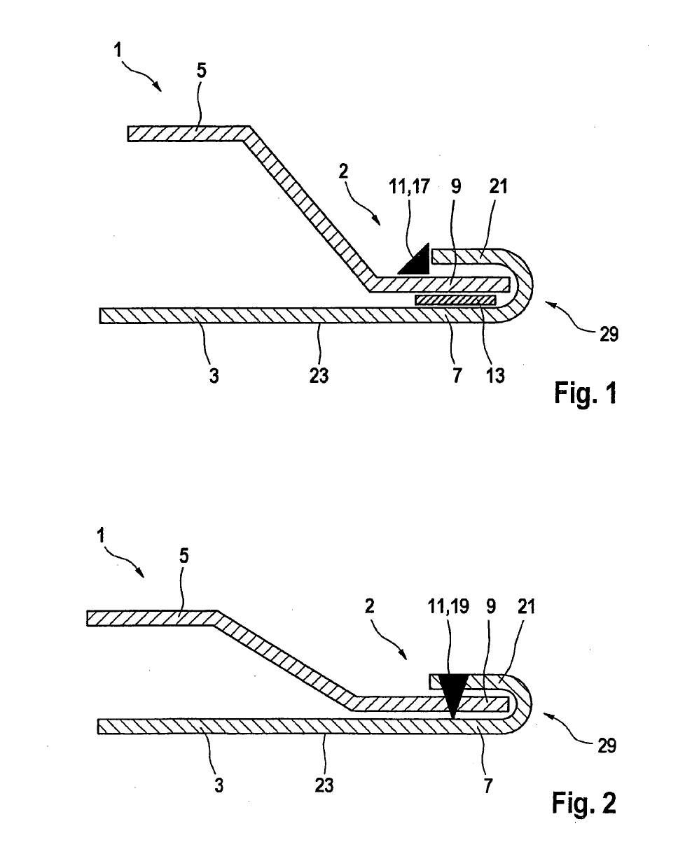

FIG. 1 shows an edge area 2 of an add-on unit 1 which is manufactured with the aid of the method according to the present invention and which is to be assembled into the body-in-white of a motor vehicle. Such an add-on unit 1 is, for example, a door or a trunk lid, a hood or a rear door, as well as a fender.

In the first method step, add-on unit 1 is manufactured from two sheets 3, 5 in such a way that an edge area 7 of first sheet 3, which is also referred to as a cladding sheet, is bent around an edge area 9 of second sheet 5. Both edge areas 7, 9 are subsequently pressed onto each other, so that a positive fit is created in edge area 2 of add-on unit 1. Sheets 3, 5 may be made of steel, an aluminum alloy or of another material.

In the next method step after the folding process is completed, folded part 21 of first sheet 3 is joined in sections with edge area 9 of second sheet 5 via welded joints 11 situated next to each other along edge area 2, i.e., in the direction perpendicular to the drawing plane.

Heat is applied on one side from the inside of finished add-on unit 1 facing away from outside 23 of first sheet 3, i.e., from the side on which fold 29 is situated.

In this exemplary embodiment, heat is applied using a laser beam. However, other methods are also suitable for applying heat on one side, e.g., a plasma welding method or friction stir welding, depending on the application.

As shown in FIG. 1, the laser-welded joints may then be implemented by a fillet joint 17 starting from the side of folded part 21 of first sheet 3. In this way, none of laser seam 11 is visible from outside 23 of first sheet 3, facing away from folded part 21, which will subsequently be visible from the outside on add-on unit 1 assembled into the body, and the visual impression of smooth outside 23 remains preserved, also due to the low heat input by the laser which only joins folded part 21 with second sheet 5. In comparison, an adverse visual effect on outside 23 would always remain if spot welding were used.

An adhesive layer 13 is additionally applied in the area of fold 21 between sheets 3, 5 which provides additional stability to the joint between sheets 3, 5. As otherwise necessary, adhesive layer 13 does not have to be hardened after the folding process but prior to assembly into the body, since the laser joint provides sufficient stability to add-on unit 1, even without the adhesive. Adhesive layer 13 is not affected by the production of laser-welded joints 111 since relatively little heat is applied by the laser on the outside of sheet 9. An overall more rigid add-on unit 1 is created by additionally using an adhesive.

FIG. 2 shows an alternative embodiment of edge area 2 of add-on unit 1. Laser-welded joint 11 is designed here in the form of a lap joint 19. This lap joint 19 is again established on one side, from the side of folded part 21 of first sheet 3. No adhesive layer 13 in the area of fold 21 is provided in this embodiment.

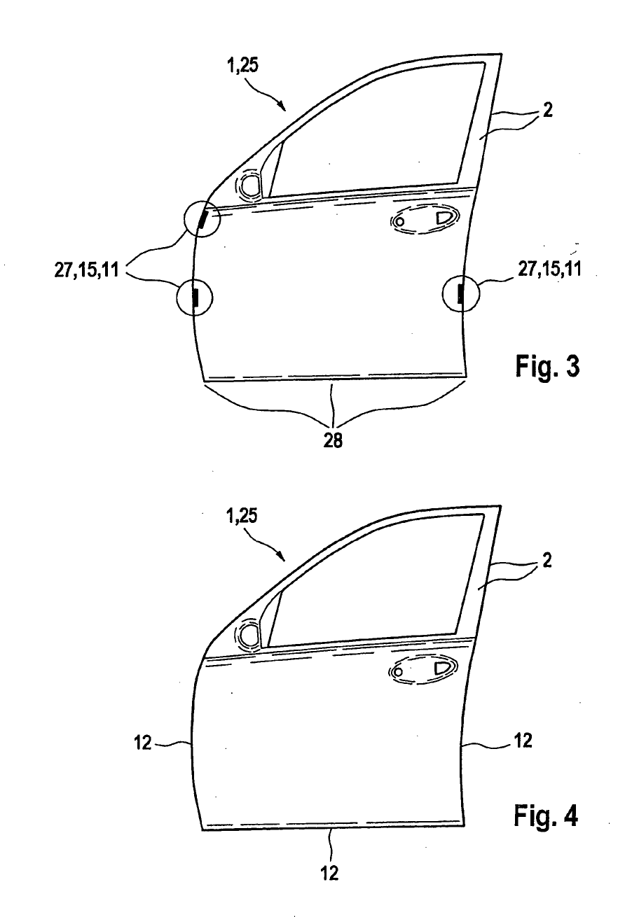

FIG. 3 shows in an example the area of edge area 2 of add-on unit 1 in which welded joints 11 are favorably situated. The exact number and position is to be determined via computer simulation, for example. A door 25 of a motor vehicle is shown in this exemplary embodiment as add-on unit 1. In order to ensure as little distortion as possible of finished add-on unit 1 due to transport or heat treatment after assembly into the body, welded joints 11 are placed exactly where the rigidity of add-on unit 1 is the greatest. In a door 25 these are areas 27, for example, at which the side impact reinforcement is situated. It may be achieved in this way that, during material expansion in subsequent thermal processes, no plastic deformations remain in the assembly of sheets 3, 5. Depending on the application, it may be sufficient to provide welded joints 11 only in these areas 27 or to add additional extra welded joints 28 which may be distributed over edge area 2 of door 25. The number and position of these possibly needed extra welded joints 28 may likewise be determined via a suitable simulation tool.

FIG. 4 shows that a circumferential laser seam 12 over the entire edge area 2 of add-on unit 1 may also alternatively be provided. Greater stability and tightness of the folding joint may be achieved in this way. Sealing of fold 21 of add-on unit 1 in the way it is otherwise carried out when PVC sealing material is used may thus be omitted.

The process of producing welded joints 11 may be carried out conventionally or with the aid of a robot-guided laser. Moreover, laser welding methods and also laser soldering methods may be used, as well as all other methods involving application of heat on one side. The laser beam path along edge area 2 of add-on unit 1 may be controlled via optical as well as adaptive methods, or by means of a predefined path.

In the method step following the manufacture of add-on unit 1, add-on unit 1 is transported to the body-in-white. This transport does not present a problem since add-on unit 1 is already dimensionally stable due to the preceding laser tacking.

Add-on unit 1 is finally inserted into an appropriate cavity into the body-in-white, i.e., door 25 is fitted into the appropriate door opening and secured there. The subsequent manufacturing steps of the body and add-on unit 1 may be performed together. Therefore, this method ensures a delay-free passage of add-on units 1, assembled into the body, through the entire manufacturing process all the way past the hardening furnace of the painting process. A direct tie-in of the add-on unit production into the body production assembly line is thus possible. Expensive subsequent work in the form of dressing the deformations of add-on unit 1, caused by thermal distortion, may be omitted.

The method and add-on unit 1 to be manufactured using the method are not restricted to the exemplary embodiments described above.

The position and the number of welded joints 11 in particular are to be determined and optimized individually, depending on the points where the particular add-on unit 1 has the greatest rigidity.

Furthermore, the method is not restricted to laser beam welding; as mentioned above, all joining methods may be used in which heat is applied on one side without noteworthy heating of the opposite side.

What is claimed is:

1. A method for manufacturing an add-on unit made up of car body sheets, the add-on unit having at least two overlapping sheets, the method comprising:
folding an edge area of a first sheet over an edge area of a second sheet; and
applying heat on one side of the first and second sheets after the folding so as to join the edge areas of the first and second sheets together in sections.

2. The method as recited in claim 1, wherein the applying of the heat is performed using a laser beam.

3. The method as recited in claim 1, wherein the edge areas of the sheets are joined together by a circumferential seam.

4. The method as recited in claim 1, further comprising applying an adhesive layer is applied on the edge area of at least one of the first and second sheets prior to the folding.

5. The method as recited in claim 1, wherein the applying of heat on one side is performed so as to produce welded joints in an area of the add-on unit having a greatest rigidity.

6. The method as recited in claim 1, wherein the edge areas are joined via a fillet joint.

7. The method as recited in claim 1, wherein the edge areas are joined via a lap joint.

8. An add-on unit which is assembled into a motor vehicle body, the add-on unit comprising:
a first sheet having a first edge area;
a second sheet having a second edge area, the first edge area being folded around the second edge area; and
a plurality of welded joints joining a folded part of the first edge area with second sheet in sections.
